(19) United States
(12) Patent Application Publication
(10) Pub. No.: US 2008/0262648 A1
(43) Pub. Date: Oct. 23, 2008

(54) DEMAND-DRIVEN SALES MODEL CAPITALIZING ON THE POWER OF ONLINE COMMUNITY

(76) Inventors: Akos KRISTON, Budapest (HU); Mihaly OROSZ, Budapest (HU); Norbert MOLNAR, Budapest (HU); Jozsef MIKLOSI, Budapest (HU)

Correspondence Address: YOUNG & THOMPSON, 209 Madison Street, Suite 500, ALEXANDRIA, VA, 22314, US

(21) Appl. No.: 11/939,613

(22) Filed: Nov. 14, 2007

Related U.S. Application Data
(60) Provisional application No. 60/858,715, filed on Nov. 14, 2006.

(51) Int. Cl. G06Q 30/00

(52) U.S. Cl. 700/233

(57) ABSTRACT

The business method according to the present invention concerns with spatially distributed configurable vending machines and their network, especially those which produce FMCG products, like beverages, hot drinks, cocktails, soups, soaps, perfumes, etc. The configurable vending machine can produce products in different phase, proportion, appearance, look and feel, etc. regarding its configuration set up. The different configurations are generally called recipe, formula which are stored in files in Internet servers. These files can be accessed by authorized persons, who can modify, delete, create new and share with other authorized users via an Internet based online community portal. The invention describes how the configurable vending machines and its network can be managed and the communication among consumers, resellers and franchise owner. The IT back office system automatically organizes product development, market survey, marketing communication, and logistics processes and serve information about actual trends, consumption, stock status in real-time. Variety of advantages are obtained by using the method invented, like a higher integration among B2C, B2B and C2C domains (processes) yielding shorter product development cycles, lower sales and development costs, and better market knowledge.

### REFERENCE TO RELATED APPLICATION

This is a regular U.S. patent application claiming priority of earlier U.S. provisional patent application Ser. No. 60/858,715, filed on Nov. 14, 2006, and entitled “Demand-driven sales model capitalizing on the power of online community”, which is hereby incorporated herein by reference.

### BACKGROUND OF THE INVENTION

1. Field of the Invention

The present invention relates generally to a demand-driven sales model that capitalizes on the power of online community, and more particularly to a method of expanding and selling so-called fast moving consumer goods (FMCG) through existing local and global networks by means of exploiting the power/advantage of well-spread community groups.

2. Background Art

Today's business evolution emerges from the Internet and the Internet related issues. New sales, purchase and management techniques are based on computer programs. A new revolution of the Internet, called Web 2.0, also covers social networking effect. The state-of-the art is to link virtual (electronic) contents and social relations together through a web based program, but there is no solution for linking physical products.

### SUMMARY OF THE INVENTION

The present invention provides a new way of product development and sales method capitalizing the power of online community and Web 2.0, especially in the field of configurable vending machines in FMCG industry. The method according to the present invention will be used to expand and sell products, basically for human consumption.

In particular, the method according to the invention is used to sell an exciting new nanoscale carbonated icy product that aims at revolutionizing soft-drink and ice cream markets through offering an exciting new product with a vast array of base flavours that can be chosen arbitrarily by the consumers at their discretion. For further details of the product (from now on, referred to as IceGel) itself and the machine suitable for dispensing it, a reference is made to our parallel international patent application no. PCT/HU2006/000099, filed on Nov. 14, 2006, the entire content of which is hereby incorporated herein by reference.

It is therefore an object of the present invention to combine the classical product development and sales methods with web 2.0 community's capability. In this business model the product development, and marketing processes occur automatically capitalizing on the consumers social interactions via the web 2.0 community portal. The competitive edges of the current technology are as follow:
1. reduces drastically the cost of the product development;
2. shortens the product development cycles;
3. considerable amount of consumers are involved in the product development process;
4. social activity serves real and useful market information in real-time.

The present invention covers every product development and marketing fields, where the Web 2.0 community model are combined with product development and production. Breakthrough innovation effectively cutting through the iterative and resource demanding process of Research and Development (from now on, referred to as R&D), that taking into consideration the complexity of the necessary information, the need for different sources to explore (such as consumer data, retail data, population data, competitive information and many others as needed) sometimes makes the process of product innovation simply just too long to react to competitive attacks or any new market situation. The way how present business processes are formulated, data collection, synthesis and even decisions concerning necessary product portfolio are automated to the full extent and can be utilized in real-time. All distribution channel members get full data on the product consumption and other social activities of the target audience visiting their outlets and aggregated data on trends in other outlets. This dramatically shortens the decision making process and helps to save the resources would have been spent on a classical R&D process. This business model even goes a step further and offers an integrated Stock Management module by assessing the trends affecting the individual outlet, proposing changes in the current portfolio, if needed, and also preparing the next product ordering in a way, that it can just be approved or based on the information changed by the person responsible for stock management. The fact, that this business model provides a new means of social interaction for the target audience also means, that those having the configured product in their outlets can get access to an invaluable marketing tool. Even though all personal data are stored and managed in a centralized way and no individual personal data will be transferred to a third party, the channel still can be “rented” for promotions launched by the outlet owners.

The subject-matter business model can be successfully applied to the following fields:
1. Tailored-made product development, where the product characteristics can be set up by the consumer.
   a. FMCG products, in which phase, proportion and look&feel are set up and produced by a vending machine.
   b. The production is spatially distributed and the consumption occurs near the vending machines, especially beverages, hot and called drinks, soaps, soups and perfumes.
   c. The product properties can be set up via the Internet and can be stored on a server.
2. Web 2.0 based social activity combined with product development and marketing.
   a. Market survey is based on the log information of the community portal.
   b. The market segmentation is based on the community self-reconstruction.
3. The logistics and stock management are managed trough the social activity.
   a. The product properties can be set up thorough the ordering process via Internet or multimedia interfaces.
   b. The logistics are driven by the social activity and the real-time consumption data.
4. Consumers can interact via the community portal regarding the product configuration process and share it with each other.

The IT back-office system is such a network, that enables the interaction via Internet among dispensers, the Web 2.0 community portal, mobile users, resellers. It enables furthermore, that physical communities may connect trough the back-office system and form virtual communities. The back-office system is integrated with an ERP system as well, to handle logistics, accounting and other business processes.

The IT back-office system has the following main parts:
1. Centrally managed servers with high Internet bandwidth and continuous access.
   a. Web 2.0 community portal: user registration, content sharing, messaging, mash-up functionalities.
   b. Network gateways to different third party systems like mobile operators, Internet Service providers.
   c. ERP system (logistics, stock management, CRM, finance).
   d. B2B portal for resellers.
2. Automatic vending machines reaches the central servers via mobile or wired connection and continuously keep the database up-to-date according to the social interactions.
   a. Multimedia user interface for configuration of the products, called “What you'd like is what you'd Get” technology.
   b. An embedded Controller, that controls the production of the product configured and can access the central servers through different ways (wired, wireless, mobile).
   c. Security module tracks the errors, reports it to the central server and stops the vending machines if the error may damage users or the machine.
3. Online user interfaces which can be reached through the central server's data and functions. This is a common browser or a mobile terminal.

### BRIEF DESCRIPTION OF THE DRAWINGS

FIG. 1 shows schematically today's business, as usual.

FIG. 2 illustrates a demand-driven sales model in general.

FIG. 3 shows various parts of the network used with the method for accomplishing the method.

FIG. 4 represents the key IceGel functions.

FIG. 5 represents a possible online IceGel mixer screen.

FIG. 6 is an exemplary profile of the community portal.

FIG. 7 illustrates a preferred embodiment of the device for producing icy products, in particular beverages, of arbitrary taste or appearance through the addition of various food additives to the ice jelly prepared.

FIG. 8 shows a (optionally world-wide) network of devices producing ice jelly according to the invention that is suitable for providing consumers e.g. with the possibility of exchanging recipes with each other via appropriate communication channels in order that they could enjoy a broad spectrum of icy products producible by means of the device according to the invention in their own homes.

### DETAILED DESCRIPTION OF THE PREFERRED EMBODIMENTS

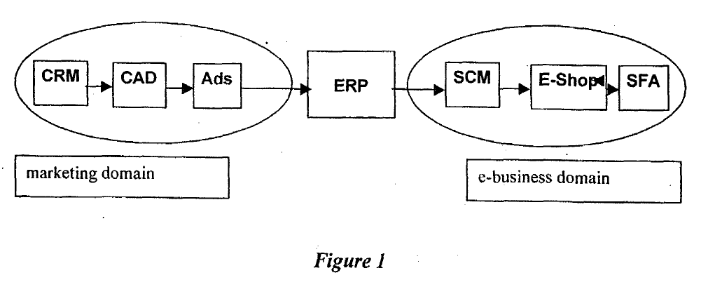

Today's main business models and product development work-flows are the following (see FIG. 1):
1. Costumer Relationship Management (CRM) systems store customer data and profiles (habits, needs, buying patterns, etc.). These data are uploaded by company employees.
2. Product development designs new products with a Computer Aided Design (CAD) system. A small number of experts queries the CRM systems to find new user groups and identify business needs and design new products to satisfy these.
3. Customers are typically reached through advertisement techniques, such as Internet banners, TV spots, etc. (Ads).
4. Enterprise Resource Planning (ERP) systems manage all of the companies processes and allocate the production line.
5. Supply Chain Management (SCM) systems coordinate the supplier's bargaining and logistics processes.
6. Customers can order products via Web based systems (e-shop) or directly from the shop.
7. Sales Force Automation (SFA) systems coordinate the sales reps and sales channels to improve sales efficiency.

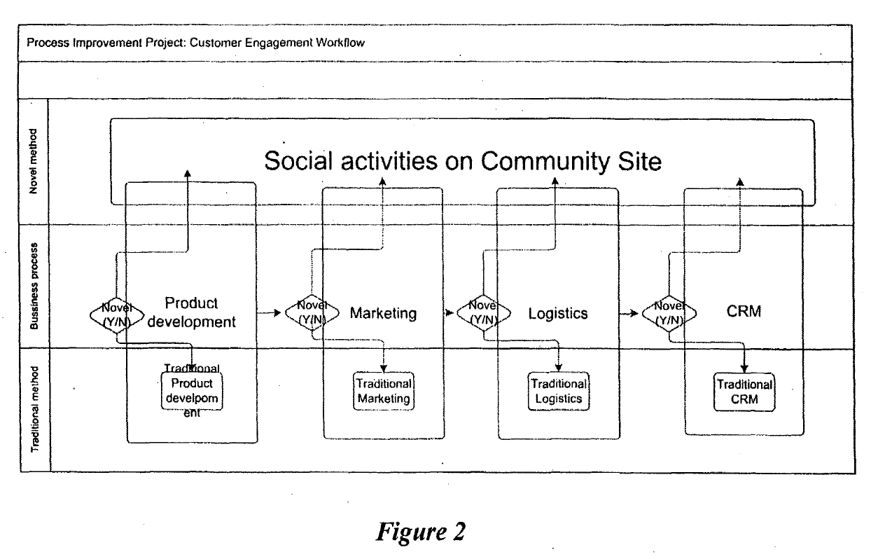

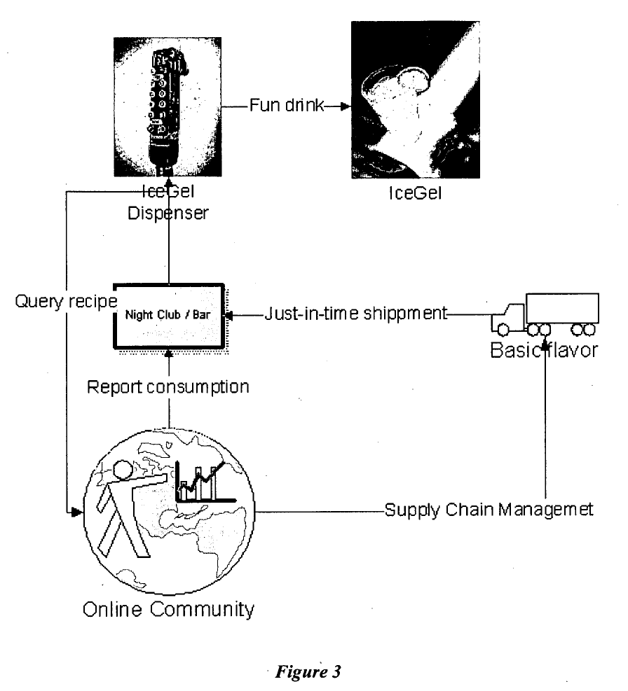

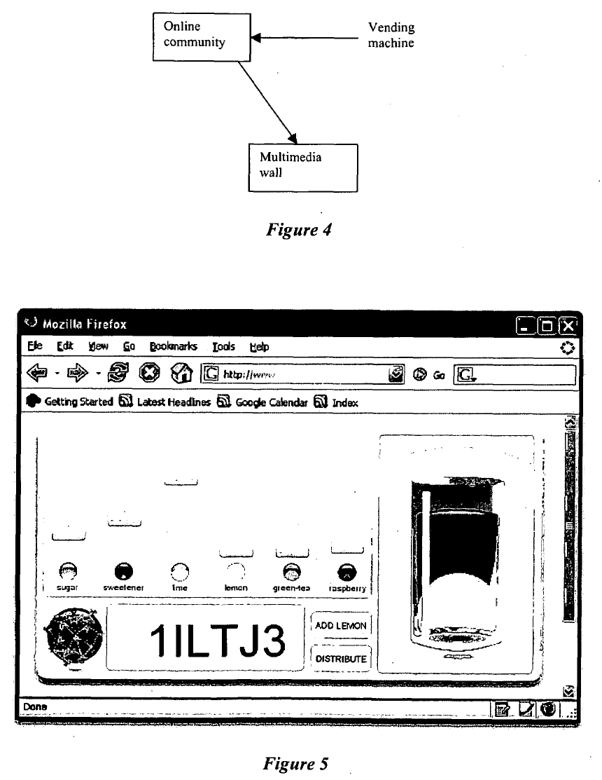

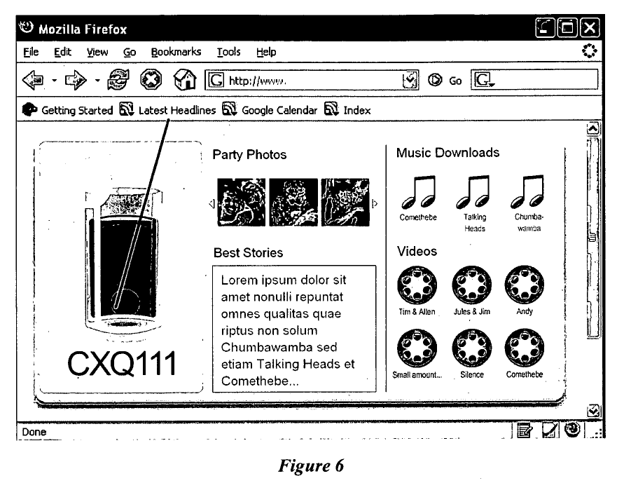

The method according to the present invention (see FIG. 2) merges the two main domains of business, marketing and e-business, into one community-based Web 2.0 portal creating demand and allowing users to develop their own products. Users who are customers are also able to
1. design their own product (CAD) by the WYLWYG technology;
2. promote this self-made product through their friend's network (ADS);
3. store, in general, users' data and profiles (CRM) in the community portal, where users upload their data themselves and link picture, video, text and other multimedia format thereto;
4. attach multimedia files to the self-made products;
5. link together the products developed, and build up the best products network of friends' friends;
6. order and buy can buy each others products or the ingredients thereof via the Internet (e-shop);
7. aggregate the critical unit or worth of products and order these from suppliers (SCM); and
8. send the on-demand business data through the network created to the supplier ERP system.

In particular, the business method according to the present invention covers

a customizable product for example IceGel (a product of the brand new phase of a homogeneous mixture of ice and carbonated drinks, both alcoholic and soft), beverage, soups, perfumes etc. and its vending machines

an online designer called ‘What You'd Like is What You Get’ (WYLWYG) technology;

a social community portal offering a higher degree of freedom to customers so as to satisfy their needs by the WYLWYG technology.

A typical representation of the above discussed demand-driven sales model shown schematically in FIG. 2 is provided by the present invention through preparing, offering, ordering, selling, etc. the product of an icy beverage, called IceGel.

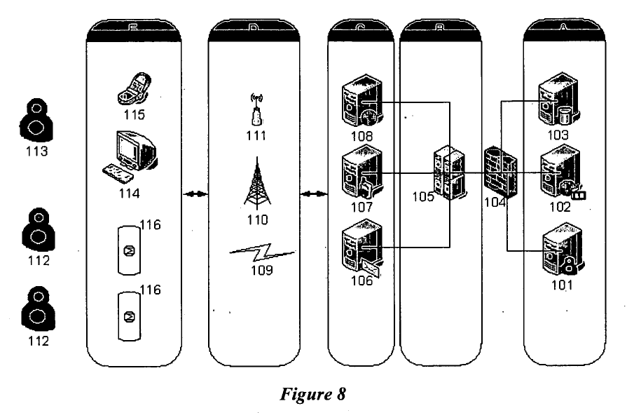

The main parts of a (IceGel) network according to the present invention, as shown in FIG. 8., are as follow:
IceGel dispensing machine (with different sizes and forms)
Flavours (at least 10 different base flavours)
Online-community portal, with recipes
Supply chain management, supplier network

The foundation of the business model is to create demand for potential customers by building an online-community. This model enables exponential growth in the number of users as in the case of MySpace.com or the International Who-is-Who. The vending machine has a built-in GSM modem which interacts with customers and the Enterprise Resource Planning (ERP) system, can monitor consumption trends and calculate the most popular recipes. Aficionados can upload their favourite recipes or formulas to share on an internet blog, download others', and try them out. Incentives shall be offered for the most popular recipes.
Reaching Typical Consumers:

The key element of the business model is to create demand for potential customers by building an online-community. The solution lets consumers create, using the online designer, their own products and brands by setting the proportions, phase, look&feel. The online-community enables the consumer to distribute the recipe and style of the imagined product, while others can connect to it. It yields to form, and restructures virtual segments over and over again, while the existence of on-site production enables users to consume tailored-made product in advance of actual trends. Our main strategy is to accommodate the forming of new segments and not force them to conform due to the use of external methods and intervention.

This model expects that all prospective customers will already consume the product sold at the vending machine through other channels. Rather than creating new consumers, this method will provide existing consumers with a new, trendier channel to produce the products. The main marketing challenge is to educate consumers on how to use the service.
Operations Strategy:

The method will offer not only products, but also a network and lifestyle. The product is offered as a part of a franchise agreement which will not be limited to the machine alone. The offerings will be scaleable in size, capacity and service levels, but everybody should use its central management system and online-community portal. The marketing will be regulated centrally, by the franchise owner

Among key network functions, as shown in FIG. 5, the franchise owner (1) develops and designs the IceGel dispenser and the WYLWYG service, (2) launches and manages the online-community site, (3) collects and analyzes operations data to refine the service process, (4) markets and communicates to customers, and (5) negotiates for and implements roll-out of service. The franchise owner manages expert contractors who are responsible for actual mechanical drawings, equipment manufacture, service installation, software integration, the product's ingredients refilling, and inventory management. By leveraging the technical know-how, assets and organizational processes of partners, the franchise owner lowers its operating risk and reduces its capital investment. To ensure well-stocked and high-performance dispensers, a wireless data service interfaces with the dispenser and the management software via the Internet, allowing dispensers to be monitored closely from central office.

The online site is the most important tool for the success of the business model. It will be developed using the latest trends in IT system development philosophy, notably Service Oriented Architecture (SOA). The IT development approach is to develop only core functions and interfaces; all others should be outsourced (portal, supply chain management, embedded web server development, etc.).

The IT system will have the following modules:
1. eRegistry and repository as the core management layer: this will coordinate the different system functions;
2. online community functions: registration, invitation, download manager (photos, video, music), consumption monitor and group formation engine;
3. online beverage designer;
4. distribution layers: as web-based portal, mobile portal, SMS and MMS interfaces;
5. peer-to-peer systems as dispensers, other community portals; and
6. external systems such as salesforce.com, ERP system.
Website Marketing Strategy

Our main marketing channel is the online-community portal and the group formation engine. This site also allows users and resellers to do marketing runs by themselves.
User, Customer Functions:

If the user is registered, they have the right to develop their own product and invite others from their circle of friends. Users can create a simple profile for the product, giving it a name or an acronym, upload photos and music. It can be stored as ‘My best product’. This profile can be public or restricted to their friends' network or a group. Every authorized person (friend or anonymous) can see these beverages and try them out if they so wish. If tried, the consumer can (has the rights to) upload the experience or feeling attached to the product. Users will be able to launch special interest groups, create micro sites, upload the main events and party schedules, and link the best beverages' profiles. All of these functions could also be reached from a mobile phone.

The most attractive possibilities are to join up to virtual parties. These parties are formed around the groups or a branch of groups all over the word, without being limited by geographical locations. For example, a group from New York could organize a virtual party with a group in London. The product aficionados go to bars in New York and London, and can talk each other via the online-community messaging functions, sending SMSs and MMSs to each other and of course drinking and tasting beverages which are linked to the group.

Public products will be ranked by consumption trends and will be highlighted on the main site as the ‘coolest product of the week’.
Resellers Functions:

Resellers have the right to follow-up group formation and invite a special interest group to the bar by organizing virtual parties. Resellers could cooperate with each other to organize these parties. These parties offer resellers the chance to attract more customers and improve their sales.

A special mobile projector box will be built for resellers, which projects the online community's activity. It works as an SMS board, where users can send messages and photos to each other between the linked nightclubs.

A franchise fee will be proportional to the other services as shown previously. There will be a minimum fee which contains the dispenser and some basic services. Another price category will be put in place for bartenders who would like to:
search within the community;
organize virtual parties;
use the set-top projector or the SMS board.

These categories will be determined following the demo site lunch.
Development Requirements

Only the core systems will be developed in-house. These are:
1. SOA architecture, registry and repository. We will use open source platforms and development environments. Most likely JAVA or related products;
2. communication protocols and interfaces between the central system and the dispenser's embedded controllers. These interfaces will coordinate the mixing of the different recipes; and
3. basic online-community functions. The main development approach is scalability and reliability; the service level must ensure that there are no failures when dispensing the beverages.

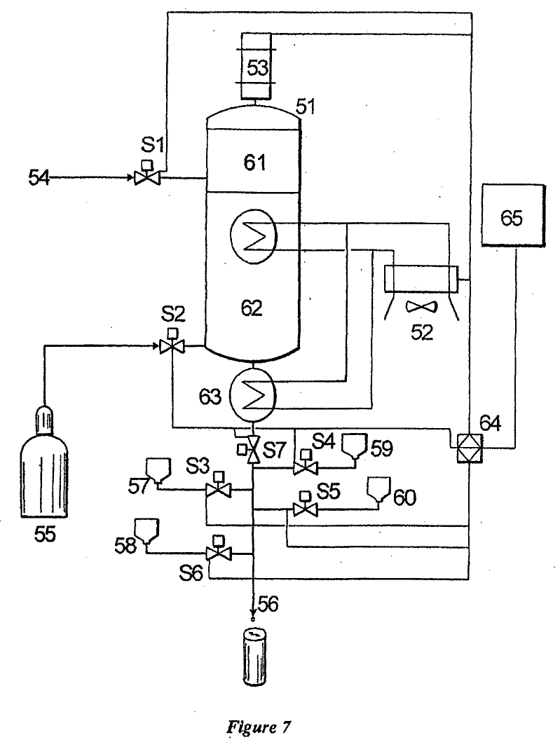

FIG. 7 illustrates a possible embodiment of the device for producing ice jelly, which is suitable for the preparation of beverages, as an exemplary FMCG product, according to arbitrary recipes after producing the ice jelly through mixing it with various food additives. The main component of the device shown in FIG. 7 is a reservoir 51 having a liquid inlet tube 54 provided with a controlled dispensing valve S1, a gas inlet tube 55 provided with a controlled dispensing valve S2 and an outlet stub 56 provided with a controlled dispensing valve S7, wherein the reservoir 51 encloses a gas space 61 and a liquid space 62. The tube 54 is in connection with the gas space 61, whereas the tube 55 and the outlet stub 56 communicate with the liquid space 62. Cooling of the liquid space 62 is performed by a cooling unit 52 under control. In addition, a secondary cooling unit 63 is inserted downstream on the outlet stub 56 before the dispensing valve S7 which serves for the after-cooling of the ice jelly produced. To ensure the physical parameters needed, the dispensing valves S1, S2, S7, the cooling unit 52 and the optional secondary cooling unit 63 are controlled by a control unit 64 which is equipped with a communication unit 65 for transmitting data to further ice jelly producing or other devices (e.g. a computer). In addition, to make gas absorption and heat exchange more efficient, the reservoir 51 can also be provided with an electric mixer 53, although the usage of such an additional unit, due to its costs, can be justified useful and as a must only for producing ice jelly on an industrial scale.

The main feature of the dispensing device shown in FIG. 7 is that it is suitable for preparing ice jelly in a closed system according to a prescribed recipe chosen by the consumer and “enriched” with various food additives, such as specific flavours, colouring agents, odorants and so on, that is, an icy beverage from the ice jelly (so-called raw jelly) produced previously by it. For this purpose, the device is provided with an arbitrary number of (in practice, usually at most ten to twelve separate pieces of) additive storage vessels which can be cooled separately (see elements 57 to 60). These storage vessels contain e.g. sweeteners, various kinds of flavouring substances, colouring agents or odorants, etc., and are connected to the downstream section of the outlet stub 56 located after the dispensing valve S7 through suitable tubings and dispensing valves (see elements S3 to S6) inserted into the latter. The control of the dispensing valves at issue is also carried out by the control unit 64 in conformity with the wish of the consumer that was previously inputted into the control unit 64 in a certain way (e.g. by means of a data input effected through a touch screen or a keyboard not shown in the drawings).

The system shown in FIG. 8, i.e. the network of ice jelly producing devices comprises a data layer A including an user authentication and database management system 101, a media storage 102, as well as a database management system 103; a firewall 104; an application server layer B including servers 105 for running logically the application for serving and coordinating the requests of users and further systems; a web service layer C including a unified messaging server 106 for handling different types of messages (e-mail, SMS, MMS, and M2M messages), a mobile information server 107 serving as an interface to the mobile communication devices, as well as a web server 108 for serving Internet based requests; an access network D including an Internet and LAN network 109, a mobile access network 110 and a wireless (WiFi, WiMax) network 111; and an end-user layer E including a consumer 112, an ice jelly designer 113, a computer 114 equipped with a web browser, a mobile phone 115 and device(s) 116 for producing ice jelly.

The ice jelly designer 113 and the consumer 112 log in to the ice jelly network through making use of mobile phones 115 or devices 116 for producing ice jelly by providing their user names and passwords. The user authentication and database management system 101 carries out their authentications and provides an access for them to the data stored in the media storage 102 and in the database management system 103, as well as to the resources at the application servers 105 for logically running the application. The user interfaces and messages are provided by the unified messaging server 106, the mobile information server 107 and/or the web server 108. The user interfaces are transmitted to the users and then back through one of the access network D, e.g. the Internet and LAN network 109, the mobile access network 110 and/or the wireless network 111. The recipes created by the ice jelly designer 113 are stored in the database management system 103 in such a manner that every formulation receives an individual code. From here the formulations are downloaded by the consumers 112 and the device(s) 116 for producing ice jelly from the database management system 103 via the built-in TCP/IP connection by providing the individual codes, on the basis of which the ice jelly producing devices 116 produce the proper end product which corresponds to the formulation created by the users. Consumption of end products prepared on the basis of the recipes requires no authentication, said products can be downloaded from the database management system 103 by any user or consumer 112. However, the ice jelly designers 113 and the users are limited to edit merely the recipes of their own creation.

The individual elements of the network of ice jelly producing devices can be installed/placed in various restaurants, places of amusement, or private houses, and these elements are in connection with the central systems formed by layers A to E. By means of the ice jelly designer 113 the consumers 112 are capable of creating their own formulations from the various flavouring substances and can save them into the database management system 103.

The new taste created by a designer can be named arbitrarily (for example, ‘Blondie-girl’) and uploaded, along with stories, pictures, and accompanying music, to portray the feeling of the customer. New members can be invited from the designer social network and persuaded to taste the new recipe. If someone would like to drink a special drink according to a special lifestyle, a query can be run on mobile devices to seek out the exact recipe. Every recipe will have a code or name. When a customer asks a bartender to make up a recipe, the vending machine will download the recipe ingredients from the server, in the correct proportion, and serve up the product. The customer has the opportunity to share their experience with other members of the online-community.

What is claimed is:

1. A method for the integration of the web 2.0 community portal functionalities with the common product development and marketing processes, comprising providing spatially distributed vending machines that can be configured by users for producing tailor-made products according to customers' needs varying in proportion, phase, appearance, look&feel, wherein said vending machines being organized in an IT network through wired or wireless connections and being capable of storing configuration files defining said properties in central file servers.

2. The method of claim 1, wherein the products are fast moving consumer goods (FMCG) products, in particular various beverages, cold and hot drinks, soaps, soups, perfumes.

3. The method of claim 1, wherein said connections are provided by a mobile network.

4. The method of claim 1, wherein said connections are provided by the Internet.

5. The method of claim 1, wherein said connections are provided by a local area network.

6. An IT system comprising
i) a web 2.0 community portal;
ii) a multimedia user Interface for the configuration of products, installed near the vending machines, that is called “What you'd like is what you'd get”;
iii) a network gateway and data acquisition system for controlling said vending machines and maintaining connections with central servers;
iv) ERP functionalities connected with the web 2.0 and the vending machines; and
v) B2B portal for resellers.
